(19) United States
(12) Patent Application Publication
(10) Pub. No.: US 2024/0065295 A1
(43) Pub. Date: Feb. 29, 2024

(54) USE OF A FEED ADDITIVE IN LOW PROTEIN FEED FOR POULTRY

(71) Applicant: Alzchem Trostberg GmbH, Trostberg (DE)

(72) Inventors: Jürgen SANS, Trostberg (DE); Robert ALBER, Prien (DE)

(73) Assignee: Alzchem Trostberg GmbH, Trostberg (DE)

(21) Appl. No.: 18/271,557

(22) PCT Filed: Jan. 3, 2022
(86) PCT No.: PCT/EP2022/050013

§ 371 Date: Jul. 10, 2023

(30) Foreign Application Priority Data
Jan. 12, 2021 (DE) 10 2021 100 383.0

(51) Int. Cl. A23K 20/142; A23K 50/75

(52) U.S. Cl. CPC A23K 20/142; A23K 50/75

(57) ABSTRACT

The present disclosure relates to the use of a composition including guanidinoacetic acid and glycine in the fattening of poultry with a low protein feed.

The present invention relates to the use of a composition containing guanidinoacetic acid and glycine in the fattening of poultry with a low protein feed.

The fixation of atmospheric nitrogen can only be occurred by plants and not by animals. Farm animals are kept for meat production, i.e. for the production of animal proteins. Farm animals can only build their endogenous proteins from fed proteins or amino acids. In farm animals, these amino acids usually come from plant feed and, to a lesser extent (e.g. fish meal), from animal feed.

The aim of a meat production is the optimal provision of all required nutrients. The optimal composition of the feed can occur under different aspects. These can be: the animal's needs, animal welfare, cost considerations or consideration of environmental aspects. For example, a recommendation of feed composition for different animals is published by the National Research Council US (NRC). A review of the historical development [Applegate, T. J., Angel, C. R. (2014) J. Appl. Poult. Res. 23: 567-575] of feed compositions shows the various reasons why feed recommendations have changed over time.

In addition, new factors have been added in recent years that were previously not taken into account in feed composition. For example, feeding high-protein feed is harmful from an environmental point of view. The animals' faeces contain more nitrogen, which is broken down into water-damaging nitrates, for example. In addition, more ammonia is emitted via the air in the barn. In this context, the production of plant proteins and the additional fertilization with nitrogen fertilizers, such as urea, must also be mentioned. The benefits of a low protein diet for broilers with environmental benefits have been analyzed and described [Aletor V. A., Hamid I. I., Niess E., Pfeffer E. (2000) Journal of Science of Food and Agriculture 80: 547-554].

Lower costs were listed as other benefits of a low protein diet. [Aftab U., Ashraf M., Jiang Z., (2006) World's Poultry Science Journal, 62: 688-701]. A diet high in vegetable protein is generally more expensive than a diet low in vegetable protein for the same energy content. A health effect with a low protein diet can also be seen. The growth of undesirable or pathogenic germs is reduced with a low protein diet [Namroud N. F., Shivazad M., Zaghari M., (2008) Poultry Science, 87: 2250-2258].

However, a low protein diet can also have disadvantages. A deficient supply of protein may result in the inability to perform important bodily functions or to perform them adequately. Various possible reasons of adverse effects in low protein diets of broilers and the effects in case of deficiency of selected protein have been investigated [Khajali F., Widemann R. F., (2010) World's Poultry Science, 66: 751-766]. Deeper investigations showed protein deficiency dystrophy, edema formation and reduced growth rate among other effects in all animals. Clinically-chemically, protein deficiency is accompanied by decreased serum albumin levels, low hemoglobin levels, and decreased extracellular potassium. Physical manifestations include frequent infections, diarrhea, hypothermia, and cachexia. In broilers, the occurrence of pulmonary hypertension has been described as an effect of protein deficient nutrition [Behrooj N., Khajali F., Hassanpour H., (2012) British Poultry Science, 53: 658-664].

In the nutrition of farm animals, it is therefore advisable to provide such a balanced protein input, which on the one hand is as low in protein as possible in order to benefit from the advantages of the low protein diet, and on the other hand is sufficiently rich in protein to avoid the symptoms of deficiency. In farm practice, due to natural variations in the feed offered and due to different needs of each animal, it is difficult or impossible to find exactly the optimal composition, so that only the advantages of the low protein diet take effect without any disadvantages being observed. In practice, it is observed that in low protein diet the average weight of animals is lower than in normal diet [Sharifi M. R., Khajali F., Jonaghani B. A., Pour H. H., Safarpour A., (2016) Research on Animal Production, 14: 51].

Also a different standard deviation and variance of animals or parts of animals or a deviation in the degree of cannibalization can occur when feeding is changed. The so-called uniformity of the stock depends on many factors. Breeders issue recommendations for this [Ross, Broiler Management Handbook 2018, p. 109 ff]. Attempts to circumvent these disadvantages have been made by adding essential amino acids. [Jiang Q., Waldroup P., Fritts C., (2005), Int. J. Poult. Sci. 4:115-122]. However, addition of single essential amino acids did not offset the disadvantage of the low protein diet relative to the standard diet, nor did supplementation with a combination of essential amino acids [Si J., Fritts C., Burnham D. (2004) Int. J. Poult. Sci. 94:1157-1568].

Further attempts to circumvent these disadvantages were made by adding non-essential amino acids. Supplementation with proline, glutamic acid and aspartic acid did not show the desired effect [Corzo A., Fritts C, Kidd M., (2005) Anim. Feed Sci. Tech. 118:319-327]. Positive effects occurred when glycine was added to a low protein diet containing 16% crude protein [Dean D, Bidner T., Southern L. (2006) Poult. Sci. 85:288-296; Awad E., Zulkifli I., (2015) Poult. Sci. 94:2772-2777]. These effects can be explained by the fact that glycine is essentially found in the keratin of feathers and supplementation with glycine primarily prevents the loss of feathers.

In summary, there is not yet an economical method to fully compensate for the disadvantages of a low protein diet for poultry.

It is therefore an object of the present invention to provide a feed additive for fattening poultry which, when low protein feed is fed, significantly increases the weight of the birds at the end of fattening compared to feeding a low protein feed alone, and preferably achieves the weight obtained when feeding a balanced high protein feed. The present invention is further directed to providing a feed additive for fattening poultry which, when low protein feed is fed, significantly improves the uniformity of the weight of the birds at the end of fattening compared to feeding a low protein feed alone and preferably achieves the uniformity obtained when fed a balanced high protein feed. Thus, an object of the feed additive is to reduce the standard deviation from the medium slaughter weight at the end of fattening.

This object is solved by a use according to claim 1. Preferred embodiments of the invention are given in the dependent claims, which may optionally be combined with each other.

Thus, according to a first embodiment, the use of i) a composition comprising guanidinoacetic acid and glycine and ii) a low protein feed for poultry having a crude protein content in the range of 14.0 to 18.5 wt. % (based on the total weight of the feed) during fattening from the 11th to the 39th day of life of the poultry, for increasing the fattening performance of the poultry and/or for increasing the slaughter weight of the poultry and/or for improving the uniformity of the slaughter weight of the poultry, is subject matter of the present invention.

Essential to the invention is that in the fattening of poultry, a composition containing guanidinoacetic acid and glycine and a low protein feed are used. In this regard, according to the present invention, a low protein feed means a feed having a crude protein content in the range of 14.0 to 18.5 wt. % (based on the feed). The crude protein content according to the present invention was determined via the Kjeldahl nitrogen content using the Büchi, AutoKjeldahl Unit K-370 instrument. Multiplying the N content by 6.25 gives the crude protein content. This is based on the assumption that an average protein contains 16 wt. % nitrogen.

According to a preferred use, it is thereby provided that the low protein feed for the poultry has a crude protein content in the range of 14.0 to 18.0 wt. %, further preferably in the range of 15.0 to 18.0 wt. %, still further preferably in the range of 16.0 to 18.0 wt. % and particularly preferably in the range of 16.5 to 18.0 wt. % and most preferably of 17.5 wt. % (based on the total weight of the feed).

It is further essential to the invention that the composition and the low protein feed are used during fattening from the 11th to the 39th day of life of the poultry (hereinafter also termed fattening phase), and thus outside the first growth phase of the animals (hereinafter also termed starting phase), which comprises the first to the 10th day of life of the poultry. In the fattening phase, a significantly larger amount of feed is consumed in absolute terms and per day compared to the starting phase as well as a greater weight gain per day is achieved. It is therefore in particular economically interesting to use a low protein feed in this fattening phase and not to intervene in the recommended diet in the sensitive starting phase from day 1 to day 10. The phase starting from day 40 is also not covered by the present invention, since the protein requirement in the diet decreases with increasing age and weight and, moreover, in modern animal fattening there is only in a few cases an interest in heavier and thus older animals.

In this regard, according to the invention, the composition containing guanidinoacetic acid and glycine and the low protein feed for poultry is used on at least one, more preferably on at least 5, still more preferably on at least 10, in particular on at least 20 and most preferably on all days from the 11th to the 39th day of life of the poultry.

According to a particularly preferred embodiment, it is thereby provided that the composition consists of guanidinoacetic acid and glycine.

Guanidinoacetic acid (syn. glycocyamine, N-guanylglycine, N-amidinoglycine; C₃H₇N₃O₂; CAS No. 352-97-6) has been commercially available as a feed additive for some time and is approved for use in poultry fattening. Multiple studies have shown, among others, that guanidinoacetic acid improves feed intake and increases fattening performance.

Glycine (syn. glycol, aminoacetic acid, aminoethanoic acid; C₂H₅NO₂, CAS No. 56-40-6) is approved as food additive E640 without quantity restriction in the EU and has also been commercially available as a feed additive for some time. Studies for chickens [Corzo A., Kidd, M. T. (2004) Poult. Sci. 83(8), 1382-4)] have shown that glycine is a limiting nutrient, although it is also produced in the animal itself.

In contrast to creatine, guanidinoacetic acid and its salts exhibit significantly higher stability in acidic aqueous solution and are only converted into creatine under physiological conditions. Guanidinoacetic acid is converted into creatine only after absorption, in particular in the liver. Thus, in contrast to creatine, the majority of the administered or fed guanidinoacetic acid is not degraded by instability reactions, e.g. in the stomach, and excreted before absorption, but is actually available for the corresponding physiological metabolic reactions.

Surprisingly, it has now been shown in feeding experiments that the administration of a composition containing guanidinoacetic acid and glycine leads to the desired benefit, namely when feeding low protein feed to increase the fattening performance and the fattening weight of the animals at the end of fattening and to improve the uniformity of the weight of the animals.

Those chickens that received a low protein feed enriched with guanidinoacetic acid and glycine achieved better growth and higher slaughter weight compared to the control group that received the same low protein feed but without the addition of guanidinoacetic acid and glycine. This effect is observed in comparison to feed enriched with glycine alone as well as in comparison to feed enriched with guanidinoacetic acid alone, wherein, completely surprisingly, a synergistic effect of the two individual substances is observed.

In the animal body, the non-essential amino acid glycine can be formed from 3-phosphoglycerate, an intermediate of glycolysis, via serine as an intermediate step. In a further step, guanidinoacetic acid is formed from glycine and L-arginine. Guanidinoacetic acid is further methylated to creatine. Creatine plays an important role in providing energy to the cell. Since guanidinoacetic acid is formed from glycine, it was not expected that a positive synergistic effect would occur when both components were administered. Therefore, without being bound by theory, it is assumed that the simultaneous administration of guanidinoacetic acid and of glycine exhibits positive effects that are not linked to energy metabolism.

The administration of the composition according to the invention containing guanidinoacetic acid and glycine can be realized in different ways. Thus, the composition can be used as a solid preparation mixed with the low protein feed or dissolved in water as a drinkable solution. Thus, subject matter of the invention is also a preferred use in which the composition a) is provided to the poultry as a solid preparation mixed with the low protein feed or b) is provided to the poultry separately from the low protein feed as a drinkable solution. In either case, the drinkable solution, the low protein feed or the low protein feed into which the composition has been mixed as a solid preparation should be provided ad-libitum. Thus, subject matter of the invention is also a preferred use in which the composition a) is provided to the poultry as a solid preparation mixed with the low protein feed ad-libitum or b) is provided to the poultry as a drinkable solution separately from the low protein feed, wherein the drinkable solution and the low protein feed are provided ad-libitum.

In the context of the present invention, the term “ad-libitum” is intended to mean an amount of low protein feed, an amount of drinkable solution, or an amount of low protein feed into which the composition has been mixed, that exceeds the daily requirement of feed and drinkable solution for the diet, based on the total number of individuals in the fattening. Thus, according to the present invention, the feed or the drinkable solution is preferably to be provided “ad-libitum”, namely in excess at free disposal of the poultry.

Thus, the preferred use ad libitum is clearly different from a specific administration of an active ingredient, which is administered, for example, daily in the form of a defined amount of 500 mg per day in individual doses and independently of other food or feed. It is all the more surprising that the sole provision of the low protein feed ad libitum, namely at the free disposal of the poultry and the composition containing guanidinoacetic acid and glycine, in particular a composition consisting of guanidinoacetic acid and glycine, leads to the desired success, namely to an increase in the fattening performance of the poultry and/or to an increase in the slaughter weight of the poultry and/or to an improvement in the uniformity of the slaughter weight of the poultry.

It has been shown that the use of guanidinoacetic acid in combination with glycine according to the invention is not limited to the substances as such. Rather, it has been shown that in the use both guanidinoacetic acid as such, namely as a free acid, or also as a salt of guanidinoacetic acid can be employed.

Particularly preferably, a salt selected from the group of alkali metal or alkaline earth metal salts of guanidinoacetic acid can be used as the salt. Sodium guanidinoacetate, potassium guanidinoacetate, magnesium guanidinoacetate or calcium guanidinoacetate are particularly preferred.

Furthermore, it has been shown that glycine can be used as such, namely as a free acid, or also in the form of a salt of glycine. Particularly preferably, a salt selected from the group of alkali metal or alkaline earth metal salts of glycine, in particular sodium glycinate, potassium glycinate, magnesium glycinate or calcium glycinate, can be used.

Thus, also a preferred use of the present invention is encompassed in which the composition comprises and in particular consists of
(i) guanidinoacetic acid as a free acid or in the form of a salt of this acid, and/or
(ii) glycine as free acid or in the form of a salt of this acid.

However, the use of a composition comprising guanidinoacetic acid as free acid and glycine as free acid is particularly preferred. Very particularly preferred is the use of a composition consisting of guanidinoacetic acid as free acid and glycine as free acid.

In connection with the underlying investigations, it has been shown that the amounts of guanidinoacetic acid and of glycine to be used are limited to a certain level and ratio.

Particularly good results can be obtained if the guanidinoacetic acid is used in an amount of at least 0.01 wt. %, preferably at least 0.02 wt. %, more preferably at least 0.03 wt. %, more preferably at least 0.04 wt. % and more preferably at the same time at most 0.20 wt. %, more preferably at most 0.15 wt. %, more preferably at most 0.12 wt. %, particularly preferably at most 0.10 wt. % and very particularly preferably at most 0.08 wt. % (in each case based on the low protein feed).

As far as the guanidinoacetic acid and/or the glycine is not used as a free acid but in the form of a salt, the weight data herein always refer to the proportion of the guanidinoacetic acid in the guanidinoacetic acid salt or the proportion of the glycine in the glycine salt.

Further good results can be obtained if the glycine is present in an amount of at least 0.01 wt. %, preferably of at least 0.02 wt. %, more preferably of at least 0.03 wt. %, more preferably of at least 0.04 wt. % and more preferably of at the same time at most 0.20 wt. %, more preferably at most 0.15 wt. %, more preferably at most 0.12 wt. %, particularly preferably at most 0.10 wt. % and very particularly preferably at most 0.08 wt. % (in each case based on the low protein feed).

According to a preferred embodiment of the use according to the invention, it is therefore provided that the guanidinoacetic acid is used in an amount of from 0.01 to 0.20 wt. %, preferably from 0.02 to 0.15 wt. % and particularly preferably from 0.04 to 0.10% (in each case based on the low protein feed), and/or that the glycine is used in an amount of from 0.01 to 0.20 wt. %, preferably from 0.02 to 0.15 wt. % and particularly preferably from 0.04 to 0.10 wt. % (in each case based on the low protein feed).

According to a preferred embodiment of the invention, it may be provided that the use is such that the composition is provided as a solid preparation mixed with the low protein feed for the poultry. Further preferably, the composition is provided as a solid preparation mixed with the low protein feed for the poultry, wherein the composition comprises guanidinoacetic acid in an amount of from 0.01 to 0.20 wt. %, preferably from 0.02 to 0.15 wt. %, and particularly preferably from 0.04 to 0.10 wt. wt. % (in each case based on the low protein feed), and/or which contains glycine in an amount of from 0.01 to 0.20 wt. %, preferably from 0.02 to 0.15 wt. % and particularly preferably from 0.04 to 0.10 wt. % (in each case based on the low protein feed), in particular consists of the stated amounts.

According to a further preferred embodiment of the invention, the use is such that the composition is provided as a solid preparation mixed with the low protein feed for the poultry, the composition consisting of guanidinoacetic acid in an amount of 0.03 to 0.08 wt. % and glycine in an amount of 0.03 to 0.08 wt. % (each based on the low protein feed).

Further preferably, a composition can be used which contains guanidinoacetic acid and glycine, in particular consists of guanidinoacetic acid and glycine, wherein the weight ratio of guanidinoacetic acid to glycine is in the range from 2:1 to 1:2, preferably from 1.8:1 to 1:1.8, more preferably from 1.5:1 to 1:1.5, particularly preferably from 1.3:1 to 1:1.3 and most preferably 1:1.

It is particularly preferred to use a composition consisting of the guanidinoacetic acid and the glycine in equal parts.

According to a very particularly preferred embodiment of the invention, the use is such that the composition is provided as a solid preparation mixed with the low protein feed for the poultry, wherein the composition consists of guanidinoacetic acid in an amount of 0.03 to 0.08 wt. % and glycine in an amount of 0.03 to 0.08 wt. % (in each case based on the low protein feed) and the weight ratio of guanidinoacetic acid to glycine being in the range from 1.5:1 to 1:1.5, in particular 1:1.

According to a preferred embodiment of the invention, it may be provided that the use is such that the composition is provided to the poultry as a drinkable solution separately from the feed. Such drinkable solutions comprise water and the composition. Further, the use may be particularly preferably carried out when drinking water, spring water, well water or tap water is used as water.

Particularly preferably, such drinkable solutions contain water, guanidinoacetic acid in an amount of 0.05 to 1.2 g per liter of water and glycine in an amount of 0.05 to 1.2 g per liter of water.

Thus, according to a further idea, the use may also be such that the composition is provided to the poultry as a drinkable solution and the drinkable solution comprises water, guanidinoacetic acid in an amount of from 0.05 to 1.2 g per 1 liter of water, particularly from 0.1 to 0.9 g per 1 liter of water, particularly from 0.15 to 0.6 g per 1 liter of water, particularly preferably from 0.2 to 0.5 g per 1 liter of water, and glycine in an amount of 0.05 g to 1.2 g per 1 liter of water, particularly from 0.1 to 0.9 g per 1 liter of water, particularly from 0.15 to 0.6 g per 1 liter of water, particularly preferably from 0.2 to 0.5 g per 1 liter of water.

Further preferably, the use may be such that the composition is provided to the poultry as a drinkable solution and the drinkable solution comprises water, guanidinoacetic acid in an amount of 0.05 to 1.2 g per 1 liter of water and glycine in an amount of 0.05 g to 1.2 g per 1 liter of water, wherein the weight ratio of guanidinoacetic acid to glycine is in the range of 1.5:1 to 1:1.5, in particular 1:1.

The invention described herein may be applied on a variety of different poultry. Particularly preferably, the composition comprising guanidinoacetic acid and glycine, in particular consisting of guanidinoacetic acid and glycine, and the low protein feed may be used with poultry selected from the group consisting of chickens, broilers, young male chickens, young female chickens.

Furthermore, the investigations on which the invention is based have shown that the low protein feed used should have a defined calorific value. On the one hand, the low protein feed should not fall below a calorific value defined for normal nutrition and healthy growth, and on the other hand, it should not exceed it in order to avoid obesity. Thus, good results have been shown when the feed for the poultry has a calorific value of 8 MJ to 20 MJ per 1 kg of feed, in particular of 10 MJ to 15 MJ per 1 kg of feed and/or the feed is a balanced feed according to Animal Nutrition Handbook, 3^{rd} Revision, 2014 Section 12, Poultry Nutrition and Feeding.

In this context, both the process and the use can be carried out in a particularly preferred way if the low protein feed comprises at least one grain, a grain flour, a grain meal or extracts thereof. Further preferred is a use in which at least one grain, a grain flour, a grain meal or extracts thereof is selected from the group:
a. corn, corn flour, corn meal or an extract thereof,
b. millet, millet flour, millet meal or an extract thereof,
c. soy, soy flour, soy meal or an extract thereof,
d. wheat, wheat flour, wheat meal or an extract thereof,
e. barley, barley flour, barley meal or an extract thereof,
f. sunflower, sunflower flour, sunflower meal or an extract thereof, and/or
g. rapeseed, rapeseed flour or rapeseed extraction meal.

Furthermore, the use can be carried out particularly preferably if the low protein feed comprises at least one further feed additive, in particular a further feed additive from the group of minerals, amino acids and vitamins. Very particularly preferably, this feed additive may be selected from the group consisting of calcium carbonate, mono- or dicalcium phosphate, lysine, methionine, threonine, thryptophan, valine, arginine and vitamins, as well as mixtures thereof.

Thus, a preferred base feed essentially comprises corn or corn ingredients, millet or millet ingredients, wheat or wheat ingredients, barley or barley ingredients, sunflower or sunflower ingredients.

In particular, the preferred feed contains only a limited amount of protein rich feed from the rapeseed and soy plant.

In particular, the invention relates to a composition comprising guanidinoacetic acid and glycine for use as a feed additive for poultry, in particular for fattening poultry, in the feeding of low protein feed to increase the fattening performance and the fattening weight of the animals at the end of fattening and to improve the uniformity of the weight of the animals.

Preferred embodiments for the composition according to the invention are described in the uses according to the invention.

The following examples are provided to illustrate the present invention.

### EXAMPLES

66,000 broilers Ross 308 at 11 days of age, i.e. at the beginning of the fattening phase (grower) at the start of fattening, were evenly distributed in 6 identical barns. Fed were pellets (<3 mm diameter, <7 mm length) until the end of the experiment. The composition of the feed was constant within a group and was not adjusted in its composition until the end of the experiment.

Air temperature was between 20 and 23° C. with humidity between 60 and 75%. Water was given through nipple drinkers, with 12 animals per nipple and the height of the nipple drinker was adjusted to the age of the animals. At the feeding dish system, 45 animals shared one feeding dish. The litter depth was 5 cm and the litter was evenly distributed.

For example, a crude protein content of 21.5 wt. % between day 11 and day 24 and 19.5 wt. % from day 25 until selling is given as a recommendation for Ross broilers. As a low protein feed, the crude protein content of which was at least 10% below the recommendations, a crude protein content of 17.5 wt. % was therefore set. The crude protein content was identified by determining the N content of the finished feed mixture using the Kjeldahl method, assuming that proteins have a nitrogen content of 16 wt. %.

The feed mixture was made of corn, soy flour, soy oil, calcium phosphates, grits, salt, sodium hydrogen carbonate, vitamin supplement: additives per kg vitamin A 13,000 I. E., vitamin D3 5,000 I. E., vitamin E 100 mg, copper 10 mg, selenium 0.42 mg. To produce the low protein feed, the amount of corn was increased and the amount of soy flour was reduced. Constant concentration of methionine was kept by further addition to the low protein feed, resulting in 0.57% methionine in the feed for both alternatives. Metabolic energy was adjusted to 3200 kcal/kg.

The mixture was otherwise prepared according to the recommendations of the Nutrition Specification for Ross Broiler, Table 2 [http://tmea.aviagen.com/assets/Tech_Center/Ross_Broiler/RossBroilerNutritionSpecs2019-EN.pdf].

Accordingly, the difference between the two feed mixtures was in the crude protein content: the standard feed had a crude protein content of 19.8 wt. %, while the low protein feed had a crude protein content of 17.5 wt. %.

From the low protein feed, four other alternatives of low protein feed were prepared by adding guanidinoacetic acid (GAA) or glycine (Gly) or guanidinoacetic acid and glycine. Pellets of the size described above were extruded with all feed mixtures.

Thus, the following feeds were available:
Experiment 1 (V-1): Standard diet with 19.8 wt. % crude protein
Experiment 2 (V-2): Low protein diet with 17.5 wt % crude protein
Experiment 3 (V-3): Low protein diet with 17.5 wt % crude protein and 0.05 wt % GAA.
Experiment 4 (V-4): Low protein diet with 17.5 wt % crude protein and 0.1 wt % GAA.
Experiment 5 (V-5): Low protein diet with 17.5 wt % crude protein and 0.05 wt % Gly.
Experiment 6 (V-6): Low protein diet with 17.5 wt % crude protein and 0.05 wt % each GAA and Gly

The animals were provided with the above-described feed ad libitum and water also ad libitum in the 6 groups. At the end of the experiment after the 38th day, the animals were removed and the average live weight was determined. Barn losses were comparable for all experimental groups, ranging from 2.18% to 2.30%.

For the collection of the standard deviation (SD), 100 individual animals from each experimental group were weighed individually during the collection process and the standard deviation was determined from this. In order to make the standard deviation of the different experiments comparable, the standard deviation of Experiment 1 was normalized to the value 1 and referred to as “standard deviation normalized” (SDnorm). SDnorm of Experiments 2 to 6 was determined by dividing the respective standard deviation by the standard deviation of Experiment 1. The results are shown in Table 1 below.

TABLE 1
Results of the feeding study

| | V-1 | V-2 | V-3 | V-4 | V-5 | V-6 |
|---|---|---|---|---|---|---|
| Final weight [g] | 2120 | 2005 | 2034 | 2027 | 2016 | 2115 |
| SD [g] | 207 | 271 | 243 | 237 | 266 | 221 |
| SDnorm | 1 | 1.31 | 1.17 | 1.14 | 1.29 | 1.07 |

As expected, the highest final weight of 2120 g and the lowest standard deviation from the medium final live weight were obtained in Experiment 1, where the feed composition was in accordance with the recommendations. A significantly reduced final live weight of 2005 g was found on a low protein diet with no further addition (Experiment 2), i.e., with a 10% reduction in the amount of protein in the feed relative to the official recommendations. SDnorm of 1.31 was significantly higher than the reference value of 1, testifying to the great inhomogeneity of the stock.

Both the addition of GAA at various concentrations in Experiments 3 and 4 and the addition of glycine in Experiment 5 resulted in only a slight improvement in final weight relative to the low protein diet of Experiment 2, from 2005 g to 2034 g, 2027 g, and 2016 g, respectively. However, in particular when fed GAA in Experiments 3 and 4, improved uniformity of the stock was achieved and SDnorm was 1.17 and 1.14. This represents a significant improvement relative to 1.31 on the low protein diet of Experiment 2, but is still significantly different from the uniformity on standard diets in Experiment 1.

In Experiment 6, in which the feed was supplemented with GAA and with glycine, the final weight of 2115 g was close to the weight of comparison group 1. With 1.07 SDnorm was only insignificantly above the comparison value of Experiment 1.

Thus, completely surprisingly, supplementation of a low protein base feed with glycine and guanidinoacetic acid was shown to almost completely offset the disadvantages of a low protein diet on growth and uniformity.

1-10. (canceled)

11. A method of fattening poultry, the method comprising:
providing i) a composition comprising guanidinoacetic acid and glycine and ii) a low protein feed for poultry having a crude protein content in the range of 14.0 to 18.5 wt. % (based on the total weight of the low protein feed); and
administering i) and ii) to poultry during fattening from the 11th to the 39th day of life of the poultry, for increasing the fattening performance of the poultry and/or for increasing the slaughter weight of the poultry and/or for improving the uniformity of the slaughter weight of the poultry;
wherein the guanidinoacetic acid is administered in an amount of from 0.01 to 0.20 wt. % based on the total weight of the low protein feed and wherein the glycine is used in an amount of from 0.01 to 0.20 wt. % based on the total weight of the low protein feed.

12. The method of claim 11, wherein the composition is provided as a solid preparation mixed with the low protein feed for the poultry.

13. The method of claim 11, wherein the composition is provided as a drinkable solution for the poultry separately from the low protein feed.

14. The method of claim 11, wherein the composition comprises guanidinoacetic acid as a free acid or in the form of a salt of guanidinoacetic acid.

15. The method of claim 11, wherein the composition comprises glycine as a free acid or in the form of a salt of glycine.

16. The method of claim 11, wherein the guanidinoacetic acid is used in the form of a salt of the guanidinoacetic acid.

17. The method of claim 16, wherein the salt of the guanidinoacetic acid is selected from the group of alkali metal or alkaline earth metal salts of the guanidinoacetic acid.

18. The method of claim 17, wherein the alkali metal or alkaline earth metal salts of the guanidinoacetic acid comprise sodium guanidinoacetate, potassium guanidinoacetate, magnesium guanidinoacetate or calcium guanidinoacetate.

19. The method of claim 11, wherein the glycine is used in the form of a salt of the glycine.

20. The method of claim 19, wherein the salt of the glycine is selected from the group of alkali metal or alkaline earth metal salts of the glycine.

21. The method of claim 20, wherein the alkali metal or alkaline earth metal salts of the glycine comprise sodium glycinate, potassium glycinate, magnesium glycinate or calcium glycinate.

22. The method of claim 11, wherein the guanidinoacetic acid is used in an amount of from 0.02 to 0.15 wt. % based on the total weight of the low protein feed.

23. The method of claim 11, wherein the guanidinoacetic acid is used in an amount of from 0.04 to 0.10 wt. % based on the total weight of the low protein feed.

24. The method of claim 11, wherein the glycine is used in an amount of from 0.02 to 0.15 wt. % based on the total weight of the low protein feed.

25. The method of claim 11, wherein the glycine is used in an amount of from 0.04 to 0.10 wt. % based on the total weight of the low protein feed.

26. The method of claim 11, wherein the composition is provided as a drinkable solution for the poultry and the drinkable solution comprises water, the guanidinoacetic acid in an amount of 0.05 to 1.2 g per 1 l of water and the glycine in an amount of 0.05 g to 1.2 g per 1 l of water.

27. The method of claim 11, wherein the guanidinoacetic acid and the glycine are used in a weight ratio of guanidinoacetic acid to glycine ranging from 2:1 to 1:2.

28. The method of claim 11, wherein the poultry is selected from the group consisting of chickens, broilers, young male chickens, young female chickens.

29. The method of claim 11, wherein administration improves the uniformity of the slaughter weight of the poultry.

30. The method of claim 11, wherein the low protein feed has a calorific value of 8 MJ/kg to 20 MJ/kg.
